(19) United States
(12) Patent Application Publication
(10) Pub. No.: US 2014/0070061 A1
(43) Pub. Date: Mar. 13, 2014

(54) TRAY AND TRAY ADAPTOR FOR HOLDING SMART TABLET DEVICE FOR USE WITH BABY STROLLER, HIGH CHAIR, WALKER, EXERCISER OR ENTERTAINMENT CENTER

(71) Applicant: BABY TREND INC., ONTARIO, CA (US)

(72) Inventor: Denny Tsai, Chino Hills, CA (US)

(73) Assignee: BABY TREND INC., ONTARIO, CA (US)

(21) Appl. No.: 14/027,031

(22) Filed: Sep. 13, 2013

Related U.S. Application Data
(60) Provisional application No. 61/700,657, filed on Sep. 13, 2012.

(51) Int. Cl. F16M 13/02; B62B 9/26

(52) U.S. Cl. CPC F16M 13/02; B62B 9/26
USPC 248/205.1; 108/25

(57) ABSTRACT

This invention relates to various trays, such as a front tray of a baby stroller, parent tray for a baby stroller, or tray for a baby high chair, walker, exerciser or entertainment center, or adaptors for such trays, that are designed hold smart tablet devices. The tray or the adaptor has a pocket for holding a smart tablet device in a substantially upright position. One example is a front tray of a stroller, a baby high chair, walker, exerciser, entertainment center, etc., with an elongated pocket in the form a recess formed in the top surface of the tray for holding a smart tablet device. Another example is an adaptor having an insert section for inserting over a tray, and an elongated pocket hanging down from the insert section for holding a smart tablet device. Yet another example is a holder for attaching to a tray using straps with hooks.

### BACKGROUND OF THE INVENTION

This invention relates to a tray, such as a front tray of a stroller, parent tray for a stroller, front tray for a baby high chair, walker, exerciser, entertainment center, etc. or a tray adaptor, designed to hold a smart tablet device such as a tablet computer in a substantially upright position.

### SUMMARY OF THE INVENTION

Smart tablet devices for children, including young children, have become more and more popular. Such devices are similar to tablet computers or book readers for adults, but are typically of smaller sizes. Typical sizes of a smart tablet device for children range from 3 by 5 to 9 by 10 inches.

An object of the present invention is to provide a tray or tray adaptor for holding smart tablet devices uses in children's products.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

Embodiments of the present invention are various trays, such as a front tray of a baby stroller, parent tray for a baby stroller, or tray for a baby high chair, walker, exerciser or entertainment center, or adaptors for such trays, that are designed for holding smart tablet devices. The tray or the adaptor has a pocket holds a smart tablet device in a substantially upright position.

One embodiment of the present invention is a front tray of a stroller, a baby high chair, walker, exerciser or entertainment center, etc., which is equipped with a smart tablet device holder. The tray has an elongated pocket in the form a recess formed in the top surface of the tray for holding a smart tablet device.

More specifically, a tray is provided for use in a stroller, baby high chair, walker, exerciser or entertainment center, adapted for holding a smart tablet device, which includes: a flat top surface; a rim extending upwardly from the top surface along its periphery; and an elongated pocket formed as a recess in the top surface.

Another embodiment of the present invention is an adaptor for holding a smart tablet device, which can be used with a front tray of a stroller, a baby high chair, walker, exerciser or entertainment center, etc. The adaptor has an insert section that can be inserted over a tray, and an elongated pocket hanging down from the insert section for holding a smart tablet device.

More specifically, a tray adaptor is provided for use with a tray of a stroller, baby high chair, walker, exerciser or entertainment center for holding a smart tablet device, the tray having a flat top surface and a raised rim along its periphery, the tray adaptor including: an insert section for inserting into the tray, the insert section including: a flat plate for resting on the flat top surface of the tray; a sidewall joined to and extending upwardly from the flat plate along at least a portion of its periphery; a flange joined to and extending outwardly from a top edge along a portion of the sidewall; and one or more hooks joined on an underside of the flange and extending downwardly for hooking into one or more holes on an inside side of the rim of the tray; an elongated pocket joined to the flange of the insert section along one edge thereof, extending downwardly below the flange.

In another embodiment, a holder is provided, adapted for mounting on a tray of a stroller, baby high chair, walker, exerciser or entertainment center for holding a smart tablet device, which includes: an elongated pocket; and two or more mounting strips attached to the pocket, each mounting strip including two or more hooks for hooking into two or more holes on the tray to attach the holder to the tray.

It is to be understood that both the foregoing general description and the following detailed description are exemplary and explanatory and are intended to provide further explanation of the invention as claimed.

### BRIEF DESCRIPTION OF THE DRAWINGS

FIGS. 1A-1F illustrate a removable adaptor for holding a smart tablet device according to a first embodiment of the present invention, to be used with a front tray of a stroller or other types of trays.

FIGS. 2A-2D illustrate a tray adapted for holding a smart tablet device according to a second embodiment of the present invention.

FIGS. 3A-3B illustrate another tray adapted for holding a smart tablet device according to third second embodiment of the present invention.

FIGS. 4A-4C illustrate a snap-on smart tablet device holder that can be used with a front tray of a stroller or other types of trays.

### DETAILED DESCRIPTION OF THE PREFERRED EMBODIMENTS

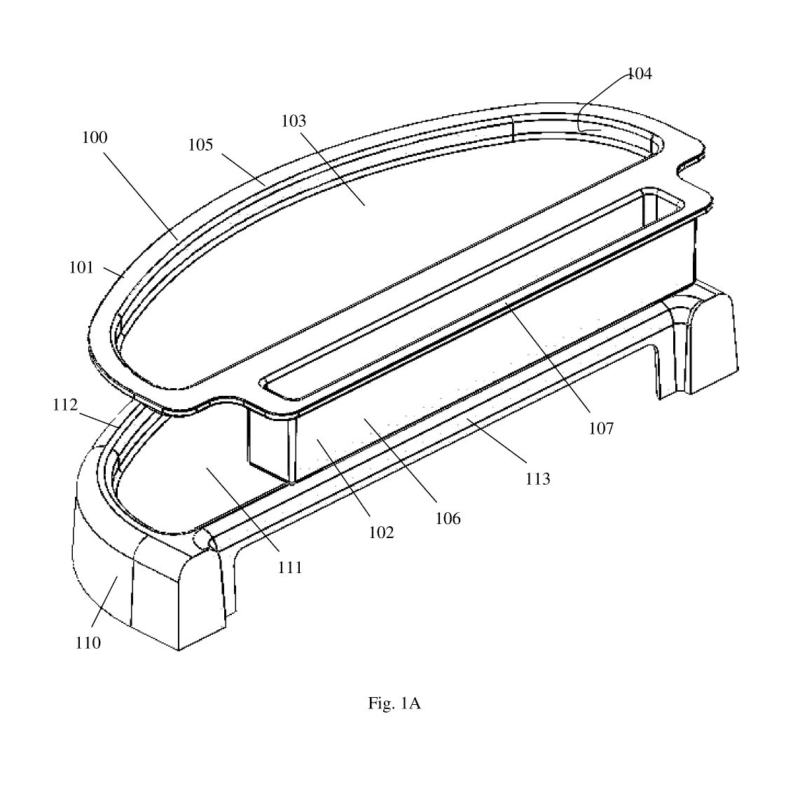

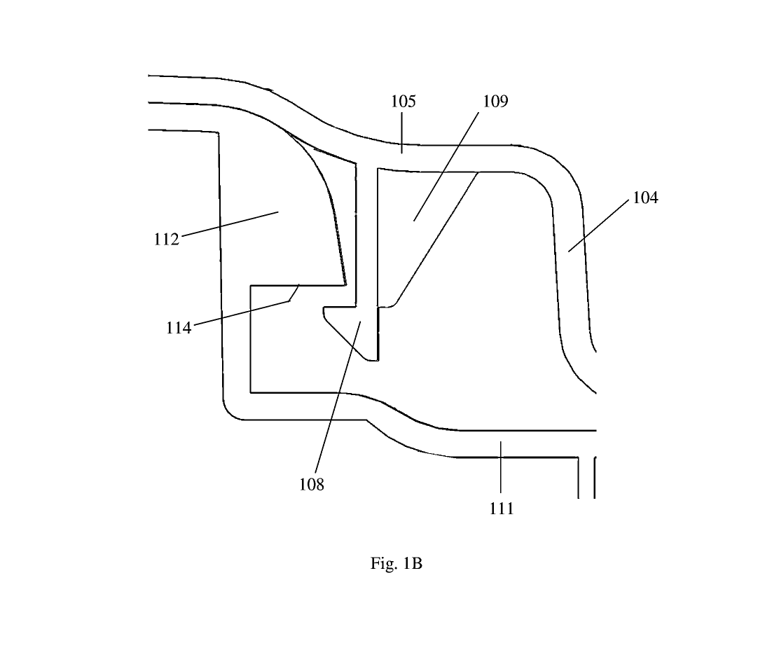

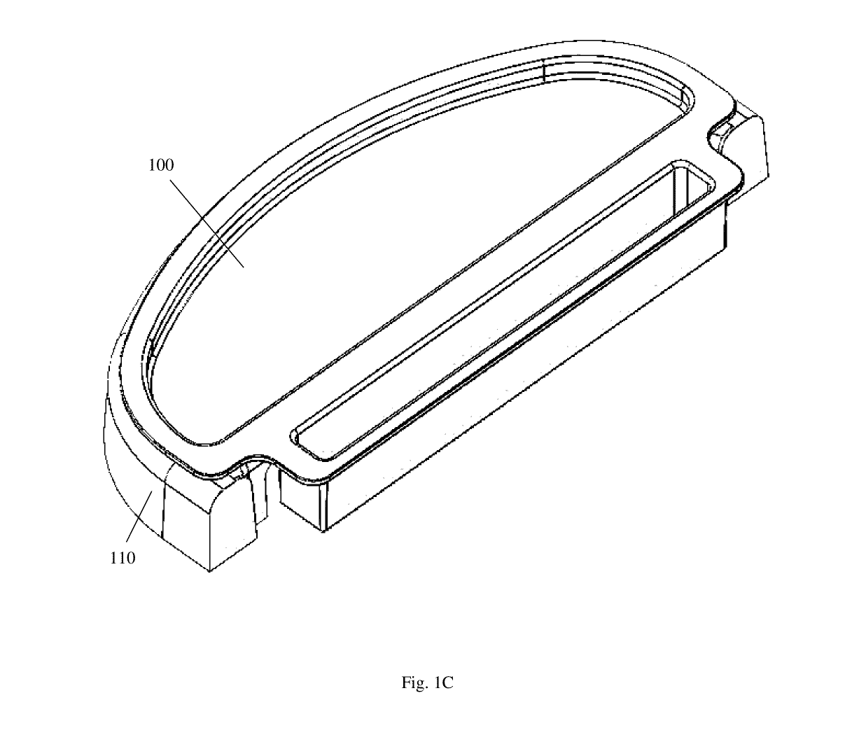

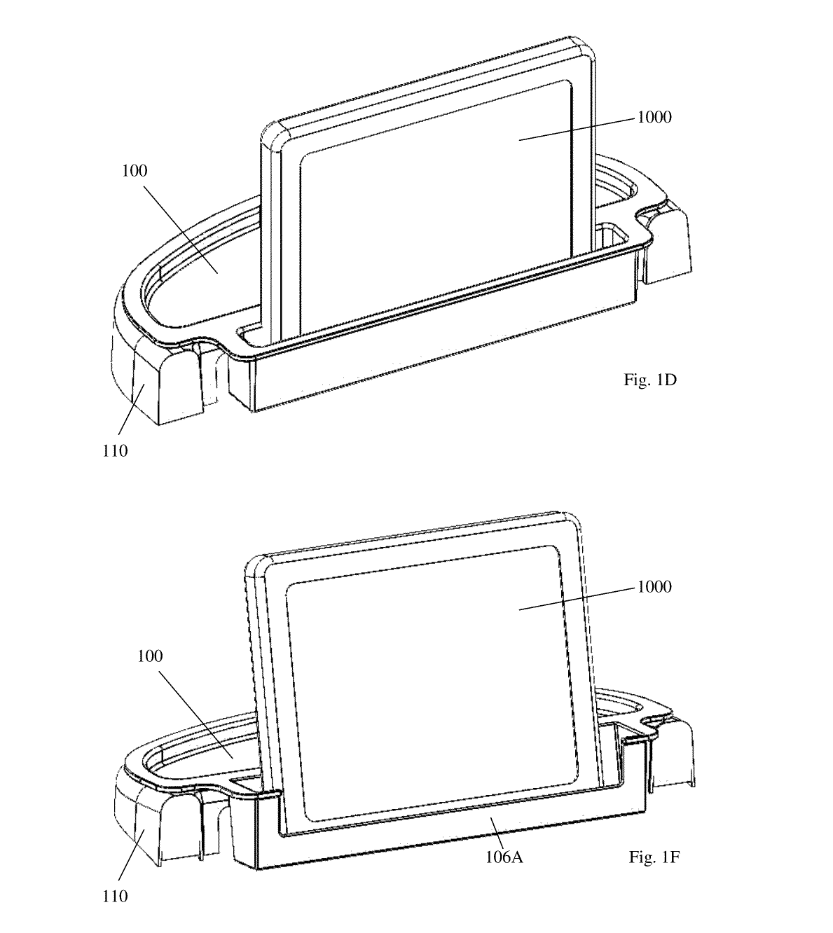

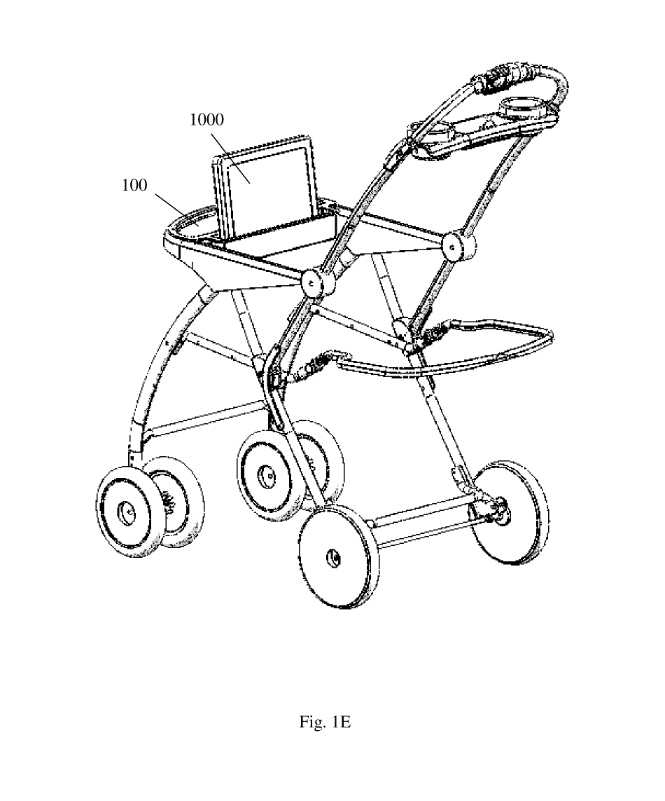

FIGS. 1A-1E illustrate a removable adaptor for holding a smart tablet device according to a first embodiment of the present invention, which can be used with a front tray of a stroller, a baby high chair, walker, exerciser or entertainment center, etc., or other types of trays. FIG. 1A shows a tray 110, which is an existing front tray of a stroller located in front of the seated child. The tray 110 has a generally horizontal flat top surface 111 with a raised rim 112 extending upwardly from the top surface along its periphery. The periphery of the tray 110 has a substantially straight portion, and the corresponding portion 113 of the rim 112 forms a straight ridge. As the tray is installed on the stroller (see FIG. 1E), the straight portion of the tray is located closest to the child seated in the stroller.

The adapter 100 has an insert section 101 and a pocket 102 connected to each other. The insert section 101 has a shape that generally matches a space above the flat surface 111 and surrounded by the rim 112 of the tray 110. More specifically, in the illustrated embodiment, the insert section 101 of the adapter 110 includes a generally horizontal flat plate 103 having substantially the same shape as the flat top surface 111 of the tray 110, a side wall 104 joined to an extending upwardly from the flat plate 103 along its periphery that substantially matches the shape of the rim 112, except that a peripheral gap may be allowed between the rim 112 of the tray 110 and the side wall 104 of the adapter 110. A horizontal flange 105 is joined to and extending outwardly from the top edge of the side walls 104 to cover the peripheral gap. As shown in FIG. 1B, a number of hooks 108 are provided on the adapter 100 located in this gap space, which can hook into a corresponding number of small holes 114 on the side surface of the rim 112 of the tray 110 when the insert section 101 is inserted with the flat plate 103 resting on the top surface 111 of the tray. The hooks 108 are attached to the underside of the flange 105 and extend downwardly. A gusset 109 may be provided between each hook and the flange 105. The hooks 108 are made of a plastic material that can be deformed slightly to remove them from the holes 114 to free the insert section 101 from the tray 110. The adaptor 100 can be easily removed from the tray and re-inserted by using the hooks 108.

Referring back to FIG. 1A, the pocket 102 has an open top and a straight, long and narrow shape formed by a bottom plate (invisible in FIG. 1A) and a plurality of side walls 106 extending upwardly from the bottom plate around the periphery thereof. One of the side walls 106 is joined at its upper edge to a straight portion of the flange 105 which corresponds to the straight ridge 113 of the tray 110. Optionally, a horizontal flange 107 may extend from the top edge of the other ones of the side walls 106, and the flange 107 may be located in the same plane as the flange 105 of the insert section 101 and joined to the flange 105. Thus, when the insert section 101 of adaptor 100 is inserted into the tray 110, the pocket 102 is located adjacent the straight side of the tray 110 and hangs below the rim 112 of the tray 110. FIG. 1C illustrates the adaptor 100 being inserted into the tray 110. FIG. 1D illustrates the adaptor 100 being inserted into the tray 110 with a smart tablet device 1000 placed in the pocket 102.

Optionally, the pocket 102 may be tilted, i.e., the sidewalls 106 are not vertical. For example, the bottom of the pocket may be located closer to the child seat than its top opening. As a result, the smart tablet device 1000 is tilted backwards as it rests in the pocket 102. Alternatively, when the thickness of a smart tablet device 1000 is less than the width of the pocket 102, the smart tablet device 1000 can tilt backwards even when the pocket 102 is not tilted.

The size of the pocket 102 is designed to accommodate typical smart tablet devices. In one example, the length, width and depth of the pocket 102 are approximately 11, 1.5, and 2 inches, respectively. Other suitable sizes may be used.

FIG. 1E illustrates a stroller incorporating the tray 110 and the adapter 100 inserted into the tray and holding a smart tablet device 1000.

In an alternative embodiment shown in FIG. 1F, the sidewall 106A of the pocket facing the seated child is partially cut out so that more areas of the smart tablet device 1000 may be exposed. The sidewall on this side may be a U-shape so that the smart tablet device can be securely help at its edges by the pocket while more of the display areas of the tablet will be visible.

Both the tray 110 and the adaptor 100 may be formed of plastic or other suitable materials. The adaptor 100 is preferably formed integrally as a single piece. When the insertion section 101 of adaptor 100 is inserted into the tray 110, the friction between the plastic pieces helps to keep the adaptor 100 in place even when a the pocket is weighted by the smart tablet device.

Many variations may be made to the above described holder. For example, the top surface 111 of tray may have recesses such as a cup holder recess, and the top surface 103 of the holder may have matching recesses that fit into the recesses of the tray. The rim 112 of the tray and/or the side wall 104 of the holder do not need to be complete circumferences, so long as they cooperate with each other to retain the insert section 101 in the tray 100. The flat plate 103 does not need to be a solid surface; it can have hollow areas or raised areas. Alternatively, the flat plate 103 can be eliminated leaving the wall 104 which will fit inside the rim 112 of the tray to keep the adapter in place. The flange 105 may also be omitted, or it may be intermittence rather than extending along the entirety of the side wall 104.

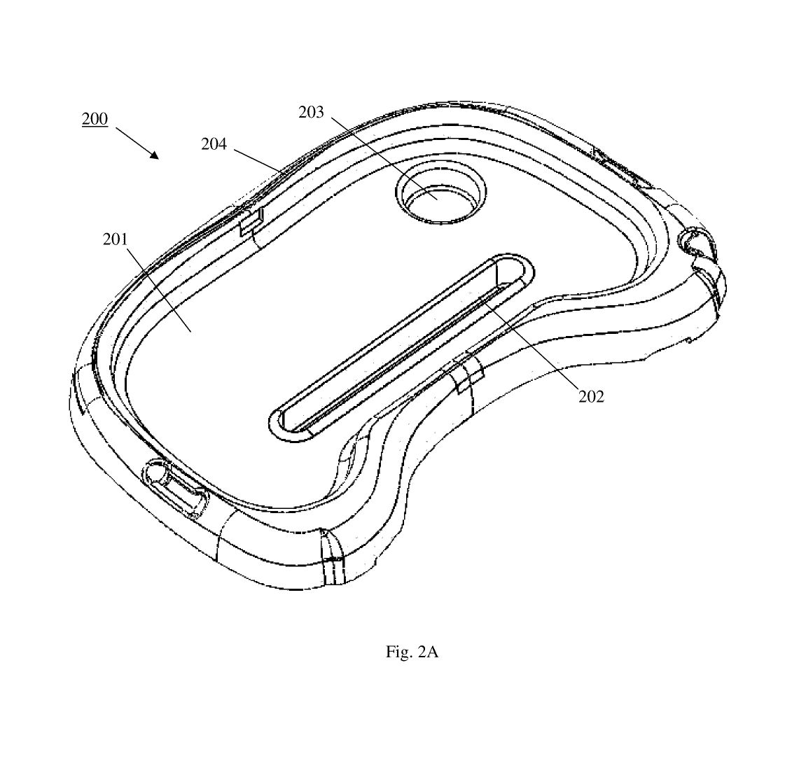

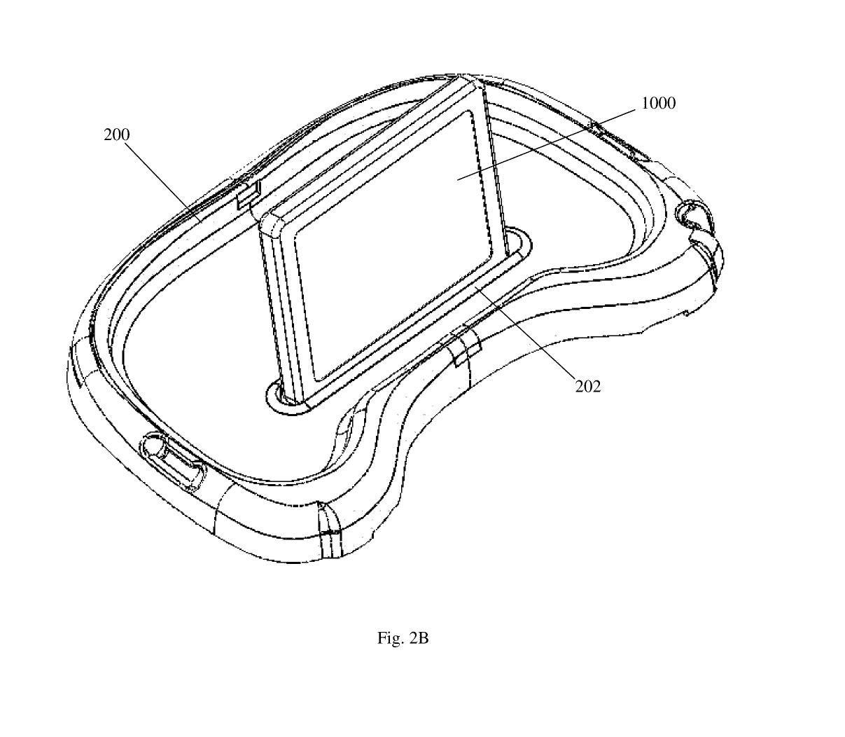

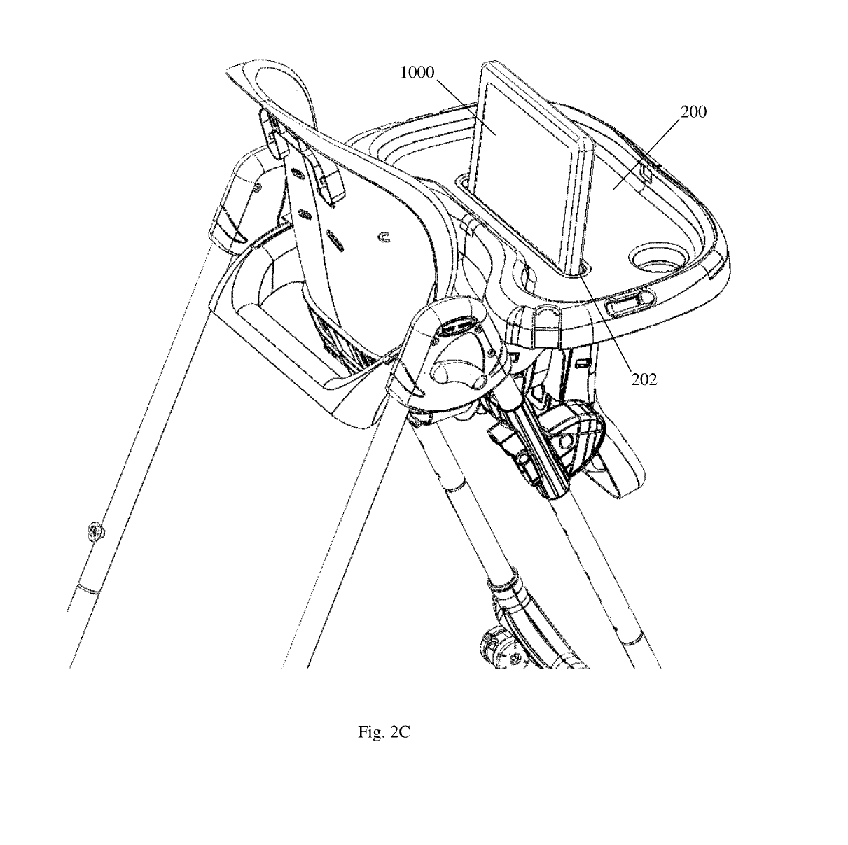

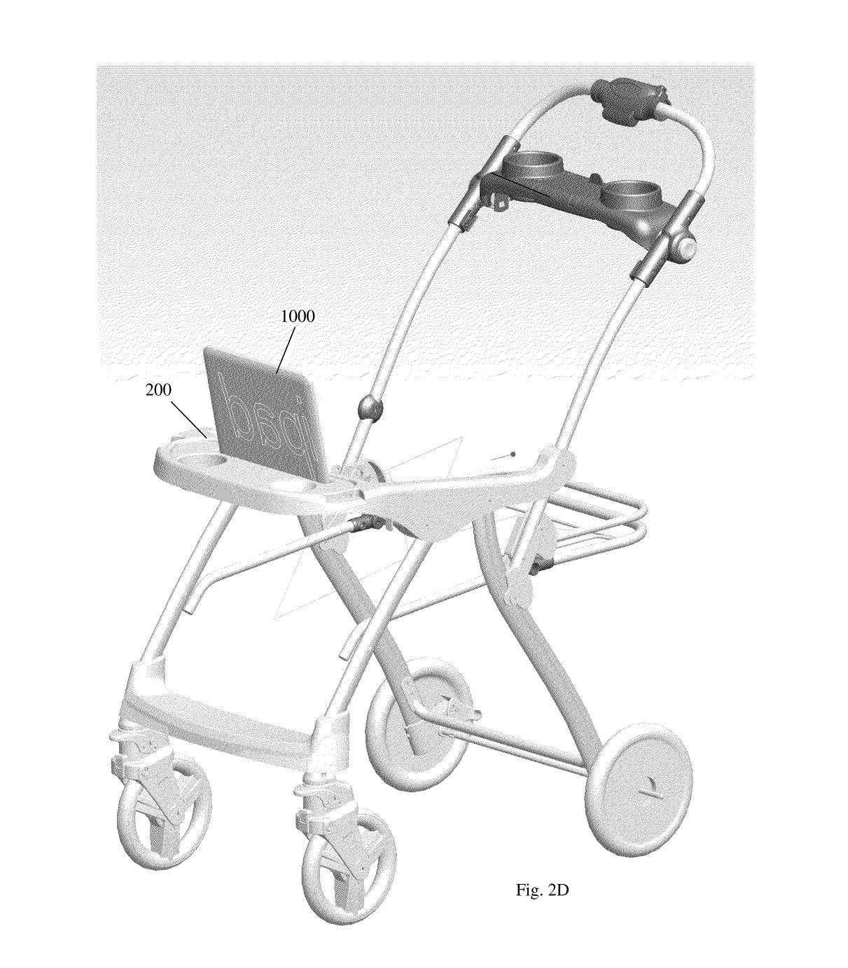

FIGS. 2A and 2B illustrate a tray according to a second embodiment, which is adapted for holding a smart tablet device. This tray may be used as a front tray of a baby high chair (see FIG. 2C for an example), a baby walker, exerciser or entertainment center, a stroller (see FIG. 2D for an example), etc. The tray may be formed of plastic or other suitable materials. As shown in FIG. 2A, the tray 200 has a top surface 201, a raised rim 204 extending upwardly from the top surface along its periphery, and a straight, elongated pocket 202 formed as a recess in the top surface.

The pocket is formed by a bottom panel and side walls. The size of the pocket 202 is designed to accommodate a smart tablet device. In one example, the length, width and depth of the pocket 202 are approximately 11, 1.5, and 2 inches, respectively. Other suitable sizes may be used. The tray 200 may have other recesses on the top surface 201, such as a round shaped recess 203 which may function as a cup holder. FIG. 2B shows a smart tablet device 1000 placed in the pocket 202 of the tray 200.

Optionally, the pocket 202 may be tilted; i.e., its sidewalls are not vertical. For example, the bottom of the pocket may be located closer to the child seat than its top opening. As a result, the smart tablet device 1000 is tilted backwards as it rests in the pocket 202. Alternatively, when the thickness of a smart tablet device 1000 is less than the width of the pocket 202, the smart tablet device 1000 can tilt backwards even when the pocket 202 is not tilted.

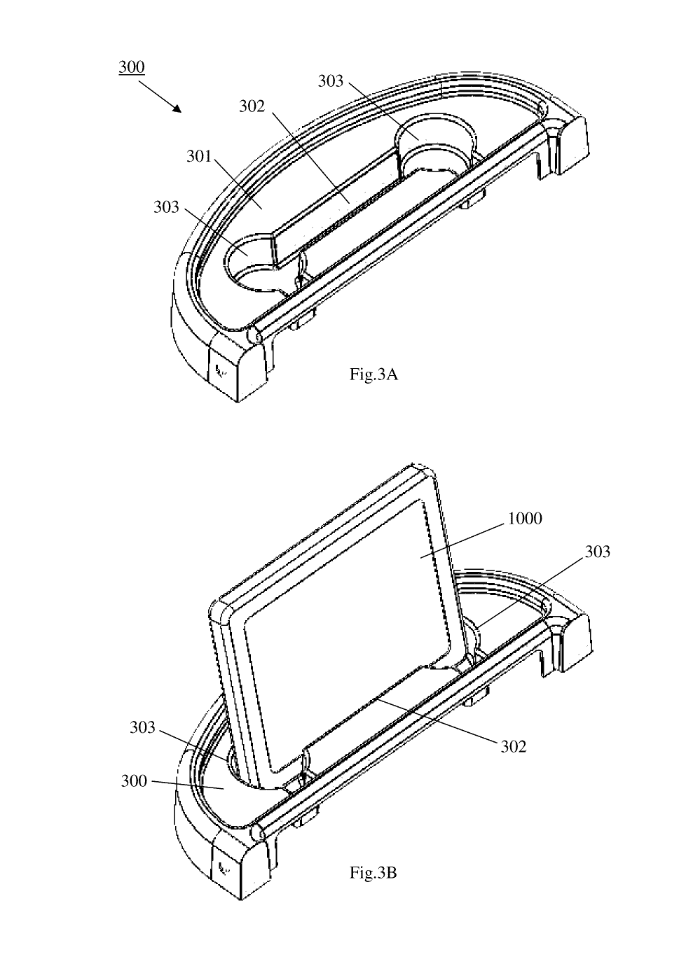

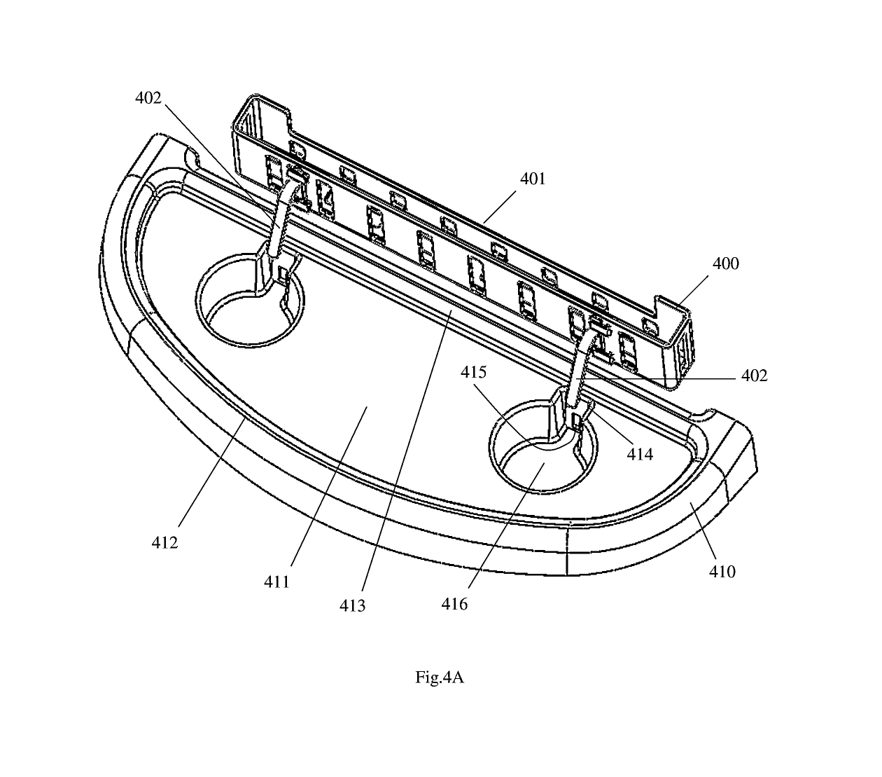

FIGS. 3A and 3B illustrate another tray adapted for holding a smart tablet device according to a third embodiment. The tray may be formed of plastic or other suitable materials. As shown in FIG. 3A, the tray 300 has an elongated pocket 302 formed as a recess in the top surface 301 of the tray. The pocket 302 is merged with two other recesses 303 at its two ends. The recesses 303 have a round shape and can function as cup holders. As shown in FIG. 3B, the merged recess 302/303 is sufficiently long to accommodate the smart tablet device 1000. This design is suitable for a relatively small tray, such as a front tray for a stroller. It can also be used as a front tray for a baby high chair, walker, exerciser or entertainment center.

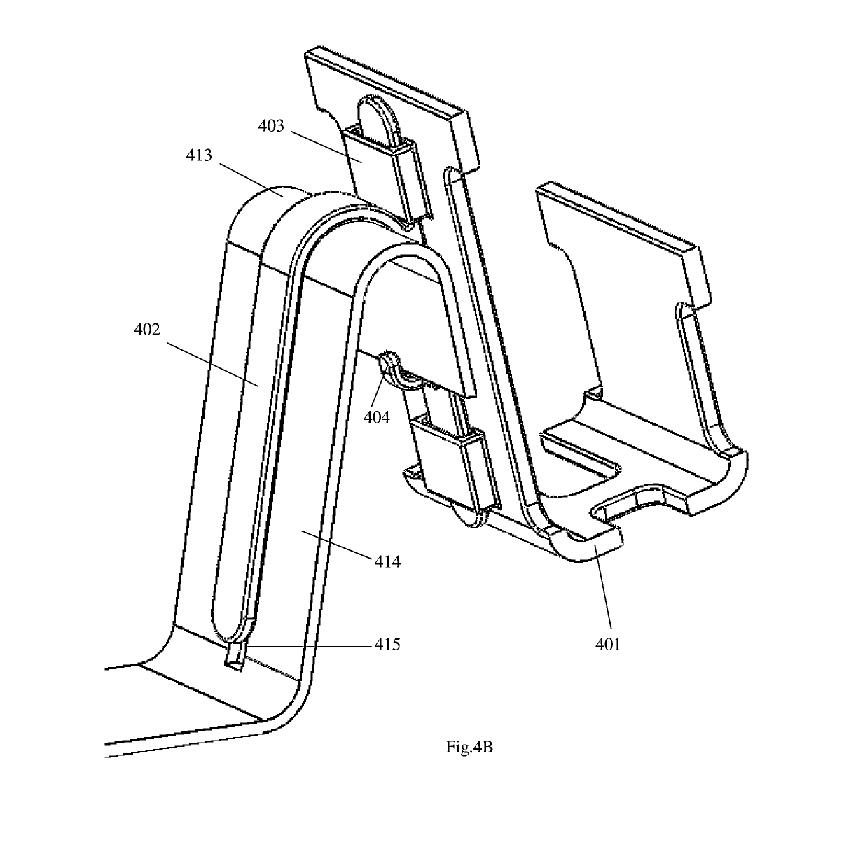

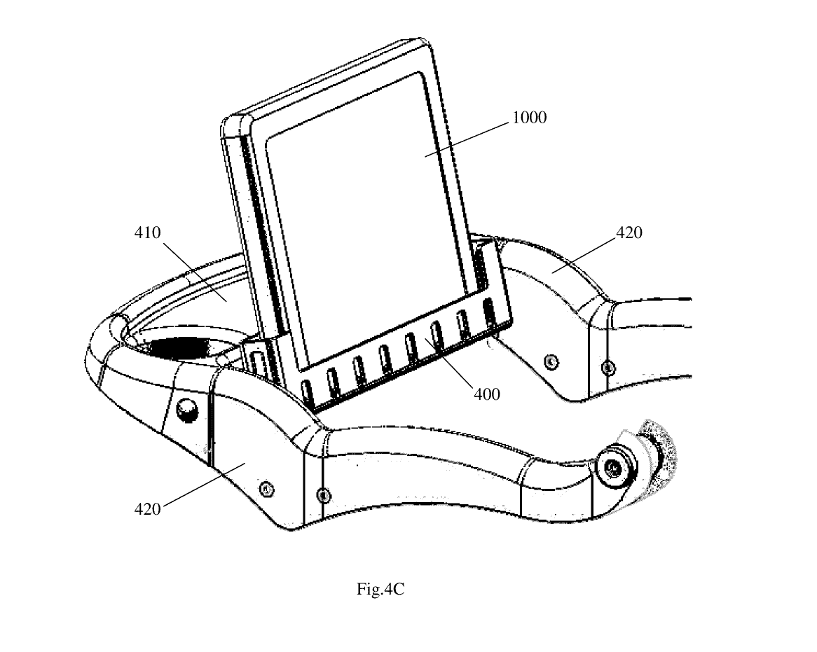

FIGS. 4A-4C illustrate a snap-on smart tablet device holder 400 that can be used with a front tray 410 of a stroller or other types of trays for holding a smart tablet device 1000. The tray 410 and pocket 400 may be formed of plastic or other suitable materials. As shown in FIGS. 4A and 4C, the tray 410 has a generally horizontal flat top surface 411 with a raised rim 412 extending upwardly from the top surface along its periphery. The periphery of the tray 410 has a substantially straight portion, and the corresponding straight portion 413 of the rim forms a straight ridge. When the tray 410 is installed on the stroller (see FIG. 4C, showing two arms 420 of the stroller holding the tray), the straight ridge 413 is located closest to the child seated in the stroller, and the smart tablet device holder 400 is to be attached to the tray along the straight portion.

As shown in FIGS. 4A and 4C, the smart tablet device holder 400 includes a pocket 401 and two (or more) mounting strips 402. The pocket 401 has an open top and a straight, long and narrow shape formed by a bottom plate and a plurality of side walls. The front sidewall of the pocket (closest to the child when mounted) may have a U-shape with a cutout are to expose more areas of the smart tablet device (see FIG. 4C). The mounting strip 402 is affixed to the pocket 401 by, for example, one or more brackets 403, or it may be integrally formed with the pocket.

As shown in FIGS. 4A and 4B (partial cut-away view of the holder 400 and the tray 410 near one of the mounting strips), at locations along the straight ridge 413 where the mounting strips 402 are to be mounted onto the tray 410, recesses 414 are formed in the top surface 411 of the tray. The recesses serve to extend the height of the rim 412 at these locations to accommodate the mounting strips 402. In the illustrated embodiment, each recess 414 is a part of a recess 416 that functions as a cup holder of the tray. Near the bottom of the recess 414, a hole 415 is formed on the sidewall of the recess for receiving a first hook (not shown) on the distal end of the mounting strip 402. The mounting strip 402 has a curved shape that generally conforms to the cross-sectional shape of the straight ridge 413 (as extended by the recess 414) and straddles over the top of the ridge 413. A second hook of the mounting strip 402 hooks to the other side of the ridge 413 opposite the side where the hole 415 is located. In the illustrated embodiment (FIG. 4B), the ridge 413 is formed by a bent sheet and the second hook 404 bends upwards and hooks to the bottom edge of the sheet on outside side of the ridge. Alternatively, the outside side of the ridge may have a hole similar to the hole 415 on the inside side, and the second hook 404 hooks into that hole.

The mounting strips 402 are preferably formed of a plastic material that can be deformed slightly to pull the first and/or the second hook out of the hooking position to remove the pocket 400 from the tray 410. In the illustrated embodiment (FIG. 4B), the first hook is more easily pulled out when removing the holder 400 while the second hook is more firmly hooked to the tray. To attached holder 400 to the tray 410, the second hook 404 of each mounting strip is hooked to the bottom edge of the ridge 413, the mounting strips 402 are placed over the ridge 413 with the pocket 401 hanging along the outside of the ridge, and the mounting strips are pressed down until the first hook is hooked into the holes 415. In this fashion, the holder 400 can be easily removed from the tray and re-attached.

In all of the above embodiments, the pockets 102/202/302 may be provided with an insert piece, disposed inside the pocket, to help more securely hold the smart tablet device in the pocket. The insert may be made of rubber, soft plastic, fabric, or other suitable materials. As mentioned earlier, various smart tabled devices may have various sizes. The pockets 102/202/302 are sized to accommodate many such sizes, and the insert piece helps to more securely hold smart tablet device that are relatively small and thin.

It will be apparent to those skilled in the art that various modification and variations can be made in the devices of the present invention without departing from the spirit or scope of the invention. Thus, it is intended that the present invention cover modifications and variations that come within the scope of the appended claims and their equivalents.

What is claimed is:

1. A tray for use in a baby stroller, high chair, walker, exerciser or entertainment center, adapted for holding a smart tablet device, comprising:
a flat top surface;
a rim extending upwardly from the top surface along its periphery; and
an elongated pocket formed as a recess in the top surface.

2. The tray of claim 1, wherein a top opening of the elongated pocket has pair of straight edges.

3. The tray of claim 1, wherein the elongated pocket includes two side walls and a bottom panel, and wherein the sidewalls are non-vertical.

4. The tray of claim 1, further including one or two substantially circular recesses, which are merged with the elongated pocket at one or both of its ends.

5. A tray adaptor for use with a tray of a stroller, baby high chair, walker, exerciser or entertainment center for holding a smart tablet device, the tray having a flat top surface and a raised rim along its periphery, the tray adaptor comprising:
an insert section for inserting into the tray, the insert section including:
a flat plate for resting on the flat top surface of the tray;
a sidewall joined to and extending upwardly from the flat plate along at least a portion of its periphery;
a flange joined to and extending outwardly from a top edge along a portion of the sidewall; and
one or more hooks joined on an underside of the flange and extending downwardly for hooking into one or more holes on an inside side of the rim of the tray;
an elongated pocket joined to the flange of the insert section along one edge thereof, extending downwardly below the flange.

6. A holder adapted for mounting on a tray of a stroller, baby high chair, walker, exerciser or entertainment center for holding a smart tablet device, comprising:
an elongated pocket; and
two or more mounting strips attached to the pocket, each mounting strip including two or more hooks for hooking into two or more holes on the tray to attach the holder to the tray.
